(19) United States
(12) Patent Application Publication
(10) Pub. No.: US 2025/0332905 A1
(43) Pub. Date: Oct. 30, 2025

(54) BATTERY UNIT AND METHOD FOR MANUFACTURING BATTERY UNIT

(71) Applicant: Mazda Motor Corporation, Hiroshima (JP)

(72) Inventors: Kazuhiro KAGEYAMA, Aki-gun (JP); Takayuki NAKAMAE, Aki-gun (JP); Megumi TAKAMORI, Aki-gun (JP); Ryota SHIMAJI, Aki-gun (JP)

(73) Assignee: Mazda Motor Corporation, Hiroshima (JP)

(21) Appl. No.: 19/185,145

(22) Filed: Apr. 21, 2025

(30) Foreign Application Priority Data
Apr. 26, 2024 (JP) 2024-072850

(51) Int. Cl. B60K 1/04; H01M 50/249

(52) U.S. Cl. CPC B60K 1/04; H01M 50/249; B60K 2001/0438; H01M 2220/20

(57) ABSTRACT

A battery unit including a battery cell housed in a battery case, wherein the battery case includes longitudinal frames extending in a front-rear direction, lateral frames extending in a left-right direction, and a base plate on the frames, the longitudinal and lateral frames are assembled into a quadrangular frame shape and surround the battery cell, the frames include ribs that couple an upper and lower end of a hollow cross section and extend in the front-rear or left-right direction, the longitudinal rib and the lateral rib come into contact with each other, the base plate covers the longitudinal and lateral frames on a top or bottom, and the base plate is joined to the longitudinal and lateral frames along a joint line that extends along the longitudinal and lateral ribs such that the joint line overlaps with the longitudinal and lateral ribs.

### CROSS-REFERENCE TO RELATED APPLICATION

The present application claims priority to Japanese Patent Application 2024-072850, filed Apr. 26, 2024, the entire contents of which are incorporated herein by reference.

### FIELD

The present disclosure relates to a battery unit disposed below a floor panel of a vehicle with a battery cell housed in a battery case, and to a method for manufacturing the same.

### DESCRIPTION OF THE RELATED ART

A battery unit 130 according to a comparative example is shown in FIG. 11. The battery unit 130 may include a battery case 132 that houses battery cells. The battery case 132 may include a pair of longitudinal frames 140 extending in parallel with a front-rear direction, a pair of lateral frames 150 extending in parallel with a left-right direction, and a plate member 160 extending in the front-rear direction and the left-right direction. The longitudinal frames 140 and the lateral frames 150 may be butted against each other, thus being assembled into a quadrangular frame shape in such a way as to surround the battery cells.

The plate member 160 may cover the longitudinal frames 140 and the lateral frames 150, which may be assembled into a quadrangular frame shape, from at least one of the upward direction or the downward direction. The plate member 160 may be joined to the longitudinal frames 140 and the lateral frames 150.

Pressure joining may be used for joining the plate member 160 to the longitudinal frames 140 and the lateral frames 150. In pressure joining, the plate member 160 may be pressed against and joined to the longitudinal frames 140 and the lateral frames 150. Specific examples of the pressure joining may include friction stir welding and series welding. The former, or the friction stir welding, is disclosed in Patent Literature 1.

### CITATION LIST

### Patent Literature

[Patent Literature 1] Japanese Patent Laid-Open No. 2020-159488

### BACKGROUND

Each longitudinal frame 140 may include a longitudinal rib 142 that couples an upper end and a lower end of a hollow cross section to each other, and that extends in the front-rear direction. Each lateral frame 150 may include a lateral rib 152 that couples an upper end and a lower end of a hollow cross section to each other, and that extends in the left-right direction.

The longitudinal frames 140 and the lateral frames 150 may be butted against each other, thus being assembled into a quadrangular frame shape. In doing so, the longitudinal ribs 142 and the lateral ribs 152 may not come into contact with each other at four corners of the battery case 132 and ribless portions N having no rib may be formed.

When the plate member 160 is pressed against and joined to the longitudinal frames 140 and the lateral frames 150 with the ribless portions N formed, the plate member 160 may not be supported by the longitudinal ribs 142 and the lateral ribs 152 and hence the plate member 160 may be deflected. The deflection of the plate member 160 could reduce the joining strength of the plate member 160 with respect to the longitudinal frames 140 and the lateral frames 150 and hence such deflection could be undesirable.

An object of the present disclosure is to join a plate member to longitudinal frames and lateral frames without causing deflection of the plate member in a battery case for a battery unit disposed below a floor panel of a vehicle.

### SUMMARY

A battery unit according to the present disclosure is a battery unit disposed below a floor panel of a vehicle with a battery cell housed in a battery case, wherein the battery case includes a pair of longitudinal frames extending in parallel with a front-rear direction, a pair of lateral frames extending in parallel with a left-right direction, and a plate member or base plate extending in the front-rear direction and the left-right direction, the pair of longitudinal frames and the pair of lateral frames are assembled into a quadrangular frame shape in such a way as to surround the battery cell, a longitudinal frame of the pair of longitudinal frames includes a longitudinal rib that couples an upper end and a lower end of a hollow cross section to each other, and that extends in the front-rear direction, a lateral frame of the pair of lateral frames includes a lateral rib that couples an upper end and a lower end of a hollow cross section to each other, and that extends in the left-right direction, when a longitudinal-frame-side connection part of the longitudinal frame for the lateral frame and a lateral-frame-side connection part of the lateral frame for the longitudinal frame come into contact with each other, the longitudinal rib and the lateral rib come into contact with each other, the base plate covers the pair of longitudinal frames and the pair of lateral frames, which are assembled into the quadrangular frame shape, from at least one of an upward direction or a downward direction, and the base plate is joined to the longitudinal frame and the lateral frame along a joint line, the joint line extending along the longitudinal rib and the lateral rib such that the joint line overlaps with the longitudinal rib and the lateral rib as viewed in an up-down direction.

When the longitudinal-frame-side connection parts of the longitudinal frames and the lateral-frame-side connection parts of the lateral frames come into contact with each other, the longitudinal ribs of the longitudinal frames and the lateral ribs of the lateral frames come into contact with each other. Consequently, the longitudinal ribs and the lateral ribs extend over the entire circumference of a quadrangular frame shape without interruptions at four corners of the battery case.

The base plate is joined to the longitudinal frame and the lateral frame along the joint line. The joint line extends along the longitudinal rib and the lateral rib such that the joint line overlaps with the longitudinal rib and the lateral rib as viewed in the up-down direction.

By pressing the base plate with a pressing tool along the longitudinal rib and the lateral rib with the base plate overlapping with the longitudinal frame and the lateral frame, the base plate can be joined to the longitudinal frame and the lateral frame along the joint line. In pressing the base plate with the pressing tool, the longitudinal ribs and the lateral ribs support the base plate. It is possible to suppress deflection of the base plate caused by pressure joining.

As described above, in the battery case for the battery unit disposed below the floor panel of the vehicle, the base plate can be joined to the longitudinal frame and the lateral frame without causing deflection of the base plate.

In one embodiment, the longitudinal-frame-side connection part is formed obliquely to the front-rear direction and the left-right direction, and the lateral-frame-side connection part is formed obliquely to the front-rear direction and the left-right direction.

By forming each of the longitudinal-frame-side connection part and the lateral-frame-side connection part obliquely, it may become easy for the longitudinal rib and the lateral rib to come into contact with each other when bringing the longitudinal-frame-side connection part and the lateral-frame-side connection part into contact with each other.

In one embodiment, the longitudinal-frame-side connection part is formed in a stepped shape, the lateral-frame-side connection part is formed in a stepped shape, and the longitudinal-frame-side connection part in a stepped shape and the lateral-frame-side connection part in a stepped shape engage with each other.

By forming each of the longitudinal-frame-side connection part and the lateral-frame-side connection part in a stepped shape, it may become easy for the longitudinal rib and the lateral rib to come into contact with each other when bringing the longitudinal-frame-side connection part and the lateral-frame-side connection part into contact with each other.

In one embodiment, the longitudinal frame includes a longitudinal auxiliary rib that couples both, e.g., opposite, lateral ends of the hollow cross section to each other, and that extends in the front-rear direction, and the lateral frame includes a lateral auxiliary rib that couples both lateral ends of the hollow cross section to each other, and that extends in the left-right direction.

The rigidity of the longitudinal frame and the rigidity of the lateral frame can be increased by the longitudinal auxiliary rib and the lateral auxiliary rib. This is advantageous for suppressing deflection of the base plate caused by pressure joining.

A method for manufacturing a battery unit according to the present disclosure is a method for manufacturing the above-mentioned battery unit, wherein the base plate is joined to the longitudinal frame and the lateral frame along the joint line by pressing the base plate with a pressing tool along the longitudinal rib and the lateral rib with the base plate overlapping with the longitudinal frame and the lateral frame.

In one embodiment, the base plate is friction stir welded to the longitudinal frame and the lateral frame along the joint line by pressing the base plate with a rotary tool, serving as the pressing tool, while rotating the rotary tool.

In the friction stir welding, a large pressing force may be applied to the base plate by the rotary tool in pressing the base plate by the rotary tool. Even in such a case, the longitudinal rib and the lateral rib support the base plate and hence it is possible to suppress deflection of the base plate caused by friction stir welding.

In one embodiment, the pressing tool includes a first electrode and a second electrode, and the base plate may be welded to the longitudinal frame and the lateral frame along the joint line by passing an electric current through the base plate via the first electrode and the second electrode in a state in which the first electrode and the second electrode are on the base plate in such a way as to be arranged in line along the longitudinal rib or the lateral rib.

### ADVANTAGEOUS EFFECTS

According to the present disclosure, the base plate can be joined to the longitudinal frame and the lateral frame without causing deflection of the base plate in the battery case for the battery unit below the floor panel of the vehicle.

### BRIEF DESCRIPTION OF THE DRAWINGS

FIG. 1 is a top plan view showing the structure of a vehicle body of a vehicle according to a first embodiment, as viewed from above.

FIG. 2 is a perspective view showing the structure of the vehicle body of the vehicle according to the first embodiment.

FIG. 3 shows a battery unit according to the first embodiment.

FIG. 4 shows a battery case according to the first embodiment.

FIG. 5 shows the internal structure of a longitudinal frame and the internal structure of a lateral frame according to the first embodiment.

FIG. 6 shows connection between the longitudinal frame and the lateral frame according to the first embodiment.

FIG. 7 shows joining of a base plate to the longitudinal frames and the lateral frames according to the first embodiment.

FIG. 8 shows a method for manufacturing the battery unit according to the first embodiment.

FIG. 9 shows connection between a longitudinal frame and a lateral frame according to a second embodiment.

FIG. 10 shows a method for manufacturing the battery unit according to a third embodiment.

FIG. 11 shows a battery unit according to a comparative example.

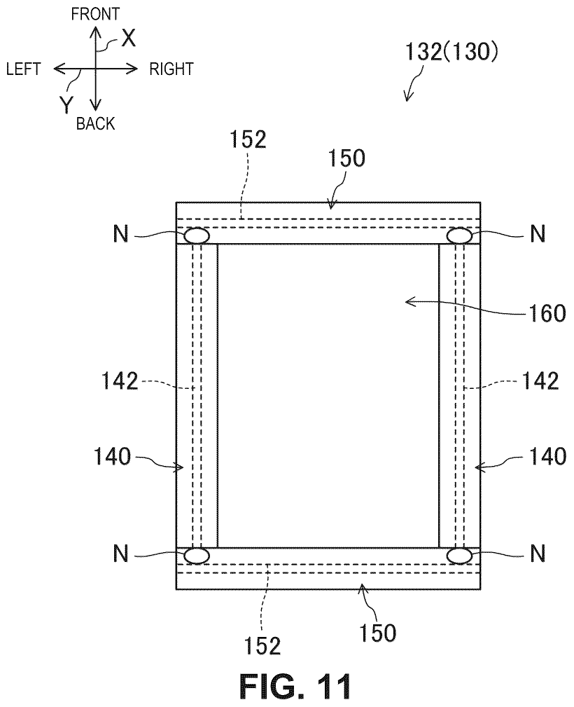

### DETAILED DESCRIPTION

Hereinafter, embodiments of the present disclosure will be described in detail with reference to drawings. The following description of the preferred embodiments is merely exemplary in nature, and is in no way intended to limit the present disclosure, its application, or uses.

### First Embodiment

A battery unit 30 of a vehicle A according to a first embodiment will be described. In the description made hereinafter, the front-rear direction, the left-right direction, and the up-down direction are determined based on the vehicle A. In the respective drawings, these directions are shown by arrows. The front-rear direction is a moving direction of the vehicle A and is indicated by “X”. The left-right direction is a vehicle width direction of the vehicle A and is indicated by “Y”. The up-down direction is a height direction of the vehicle A and is indicated by “Z”.

### Vehicle

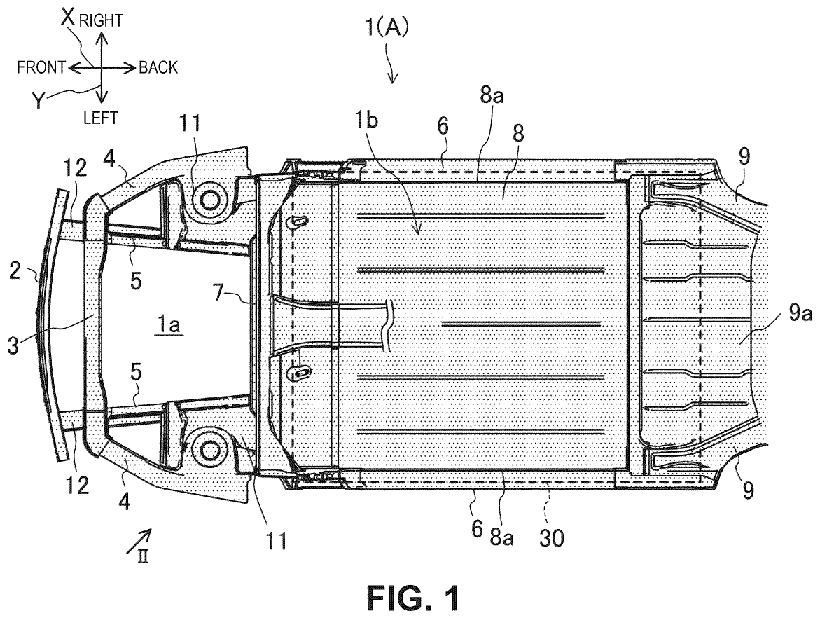

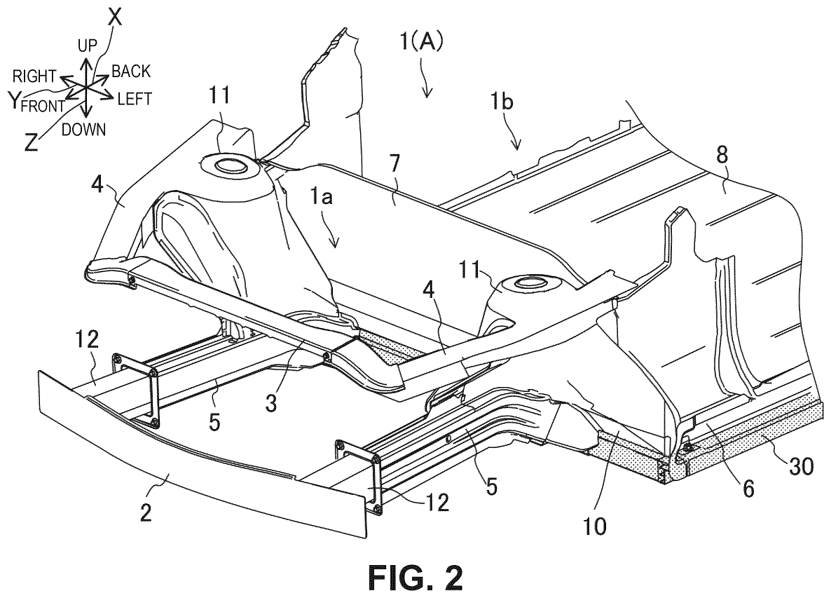

FIG. 1 is a top plan view showing the structure of the vehicle body 1 of the vehicle A, as viewed from above. FIG. 2 is a perspective view showing the structure of the vehicle body 1 of the vehicle A, as viewed from a direction shown by arrow II in FIG. 1. The vehicle A may include, as components that constitute the vehicle body 1, a bumper beam 2, a shroud upper member 3, a pair of apron members 4, a pair of front side frames 5, a pair of side sills 6, a dash panel 7, a floor panel 8, and rear side frames 9. The vehicle A includes torque boxes 10, suspension housings 11, and crush cans 12. The vehicle A may include the battery unit 30, e.g., battery pack.

The vehicle A may be an electric vehicle and travels by driving a motor. In an implementation, the motor may be mounted in a front space la provided at the front part of the vehicle body 1. A vehicle cabin 1b may be formed at the intermediate part of the vehicle body 1. The floor panel 8 may be provided at the intermediate part of the vehicle body 1. The floor panel 8 may expand or extend in the front-rear direction and the left-right direction, and may have a substantially rectangular shape as viewed in the up-down direction. The floor panel 8 may constitute the floor surface of the vehicle cabin 1b.

The battery unit 30 may be mounted in the vehicle A. The battery unit 30 may be a power source that drives the motor for running the vehicle A. As shown by a broken line in FIG. 1, the battery unit 30 may be disposed below the floor panel 8 of the vehicle A in such a way as to expand or extend along the floor panel 8.

The battery unit 30 may have an external appearance substantially the same as that of the floor panel 8, the external appearance having a rectangular shape as viewed in a top plan view. The battery unit 30 will be described below.

As shown in FIG. 2, partitioning may be provided between the front space 1a and the vehicle cabin 1b by the dash panel 7. The dash panel 7 may expand or extend in the up-down direction and the left-right direction.

The pair of side sills 6 may be provided on both left and right sides of the intermediate part of the vehicle body 1. Each side sill 6 may be formed of a columnar member, and may be excellent in strength and rigidity. The pair of side sills 6 may extend in parallel with the front-rear direction along edge parts 8a of the floor panel 8 on both sides in the left-right direction. The pair of side sills 6 may constitute the vehicle body 1 together with the floor panel 8.

The pair of rear side frames 9 may be coupled to the rear ends of the pair of side sills 6. The pair of rear side frames 9 may extend rearward. A rear floor panel 9a formed continuously with the floor panel 8 may be provided between the pair of rear side frames 9.

As shown in FIG. 1 and FIG. 2, the pair of front side frames 5 may extend forward from the front side of the floor panel 8 while being spaced apart from each other in the left-right direction. The pair of front side frames 5 may constitute the vehicle body 1 together with the floor panel 8. As viewed in the up-down direction, the pair of front side frames 5 may be slightly inclined in such that they are farther apart from each other in the left-right direction as they go to the front side. Each front side frame 5 may be formed of a columnar member having a rectangular cross section.

The front side frames 5 may be joined to the front end part of the floor panel 8 and to the torque boxes 10.

The suspension housings 11 may be provided in front of the respective end parts of the dash panel 7 in the left-right direction. The lower end parts of the suspension housings 11 may be coupled to the front side frames 5. The apron members 4 may be coupled to the upper end parts of the suspension housings 11.

Each apron member 4 may extend forward from the outer side of each suspension housing 1. The apron member 4 bends more inward in the left-right direction as it goes to the front side. The front ends of the pair of apron members 4 may be coupled to each other by the shroud upper member 3 extending in the left-right direction.

The bumper beam 2 extending in the left-right direction may be disposed at a position lower than and in front of the shroud upper member 3. The front ends of the front side frames 5 may be coupled to both end parts of the bumper beam 2 in the left-right direction via the crush cans 12.

### Battery Unit

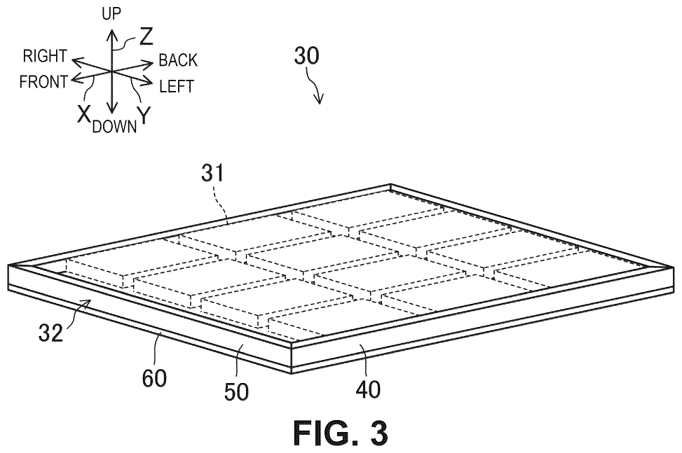

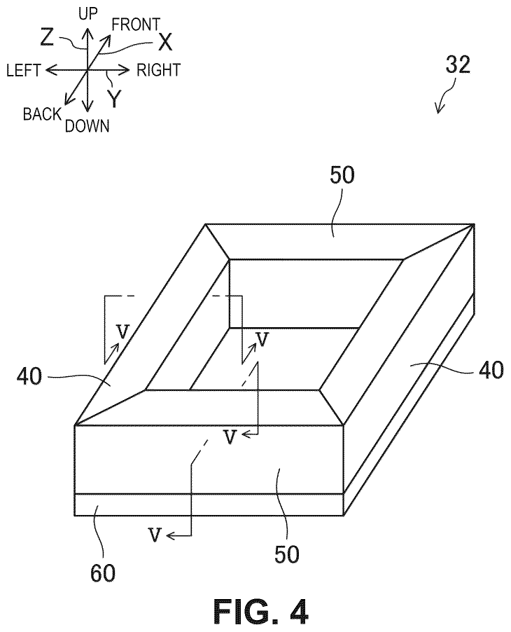

FIG. 3 is a perspective view showing the battery unit 30. FIG. 4 is a perspective view showing a battery case 32. The battery unit 30 may include a plurality of battery cells 31 and the battery case 32. The plurality of battery cells 31 may be housed in the battery case 32. The battery unit 30 may be disposed below the floor panel 8 of the vehicle A with the battery cells 31 housed in the battery case 32.

Each battery cell 31 may be, e.g., a lithium ion battery or the like. All of the plurality of battery cells 31 may be electrically connected with each other and may be capable of outputting a predetermined high voltage. In an implementation, by taking into account loading efficiency in the battery case 32, the battery cells 31 may each be formed in a rectangular block shape (rectangular parallelepiped shape). In an implementation, twelve battery cells 31 may be disposed in the battery case 32 to be arranged in the proximity of each other such that four battery cells 31 are arranged in the left-right direction and three battery cells 31 are arranged in the front-rear direction.

The battery case 32 may include a pair of longitudinal frames 40, a pair of lateral frames 50, and a base plate 60.

The pair of longitudinal frames 40 may be spaced apart from each other in the left-right direction, and may extend (e.g., lengthwise) in parallel with the front-rear direction. The pair of lateral frames 50 may be spaced apart from each other in the front-rear direction, and may extend in parallel with the left-right direction. In the battery case 32, the longitudinal frames 40 and the lateral frames 50 may be assembled into a quadrangular frame shape, as viewed in the up-down direction, in such a way as to surround the battery cells 31. In an implementation, the battery case 32 may be formed into a rectangular frame shape in which long sides extend in the front-rear direction, and short sides extend in the left-right direction. The longitudinal frames 40 may be fixed to the side sills 6.

In the following, the side toward the inner side of the battery case 32 (the side on which the battery cells 31 are disposed) in the front-rear direction (the left-right direction) may be referred to as the inner side in the front-rear direction (the left-right direction), and the side toward the outside of the battery case 32 (the side on which the battery cells 31 are not disposed) in the front-rear direction (the left-right direction) may be referred to as the outer side in the front-rear direction (the left-right direction).

The base plate 60 may have a thickness in the up-down direction, and may extend in the front-rear direction and the left-right direction (e.g., may have a flat, planar shape). The base plate 60 may cover the longitudinal frames 40 and the lateral frames 50, which are assembled into a quadrangular frame shape, from at least one of the upward direction or the downward direction. In an implementation, the base plate 60 may cover the longitudinal frames 40 and the lateral frames 50, which may be assembled into a quadrangular frame shape, from the downward direction (the bottom direction). The base plate 60 constitutes the bottom surface of the battery case 32.

The base plate 60 may cover the lower side of the longitudinal frames 40, the lower side of the lateral frames 50, and a space defined by the longitudinal frames 40 and the lateral frames 50 from the downward direction. In an implementation, a lid that covers the upper side of the battery case 32 from above may also be provided.

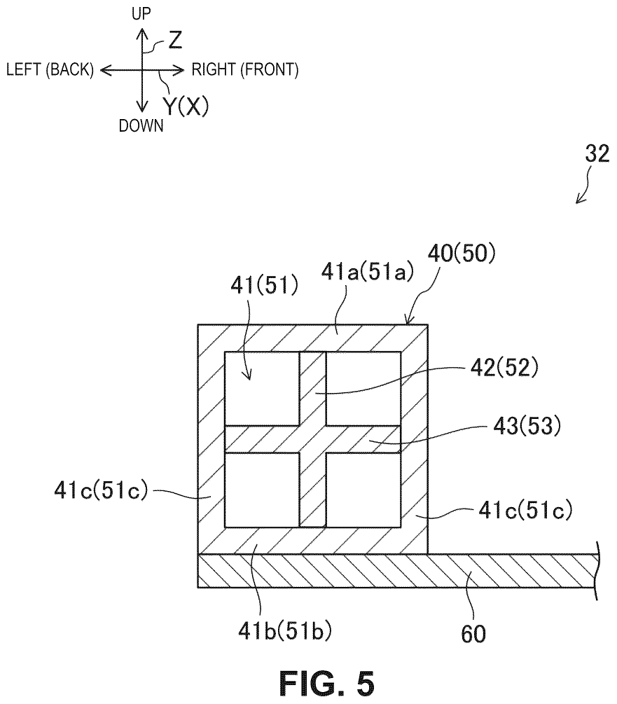

FIG. 5 shows the internal structure of the longitudinal frame 40 and the internal structure of the lateral frame 50. FIG. 5 is a cross-sectional view taken along line V in FIG. 4. In FIG. 5, reference symbols related to the longitudinal frame 40 are indicated without brackets, and reference symbols related to the lateral frame 50 are indicated with brackets.

Each longitudinal frame 40 may be a square pipe. The transverse cross section of the longitudinal frame 40 as viewed in the long-length direction (front-rear direction) may have a hollow shape. The longitudinal frame 40 may have a hollow cross section 41. The hollow cross section 41 of the longitudinal frame 40 may have a quadrangular frame shape.

The longitudinal frame 40 may include a longitudinal rib 42. The longitudinal rib 42 may couple an upper end 41a and a lower end 41b of the hollow cross section 41 of the longitudinal frame 40 to each other (e.g., the longitudinal rib 42 may extend between and be coupled to the upper end 41a and lower end 41b of the hollow cross section 41 of the longitudinal frame 40. The longitudinal rib 42 may extend in the front-rear direction from one end to the other end of the longitudinal frame 40.

In an implementation, the longitudinal frame 40 may include a longitudinal auxiliary rib 43. The longitudinal auxiliary rib 43 may couple (the center parts in the up-down direction of) both, e.g., opposite, lateral ends 41c of the hollow cross section 41 of the longitudinal frame 40 to each other. The longitudinal auxiliary rib 43 may extend in the front-rear direction from one end to the other end of the longitudinal frame 40. In the hollow cross section 41 of the longitudinal frame 40, the longitudinal rib 42 and the longitudinal auxiliary rib 43 may intersect with each other in a cross shape.

Each lateral frame 50 may be a square pipe. The transverse cross section of the lateral frame 50 as viewed in the long-length direction (left-right direction) may have a hollow shape. The lateral frame 50 may have a hollow cross section 51. The hollow cross section 51 of the lateral frame 50 may have a quadrangular frame shape.

The lateral frame 50 may include a lateral rib 52. The lateral rib 52 may couple an upper end 51a and a lower end 51b of the hollow cross section 51 of the lateral frame 50. The lateral rib 52 may extend in the left-right direction from one end to the other end of the lateral frame 50.

In an implementation, the lateral frame 50 may include a lateral auxiliary rib 53. The lateral auxiliary rib 53 may couple (the center parts in the up-down direction of) both lateral ends 51c of the hollow cross section 51 of the lateral frame 50 to each other. The lateral auxiliary rib 53 may extend in the left-right direction from one end to the other end of the lateral frame 50. In the hollow cross section 51 of the lateral frame 50, the lateral rib 52 and the lateral auxiliary rib 53 may intersect with each other in a cross shape.

Each of the longitudinal frame 40 and the lateral frame 50 may be formed by, e.g., extrusion molding of aluminum.

### Connection Between Longitudinal Frame and Lateral Frame

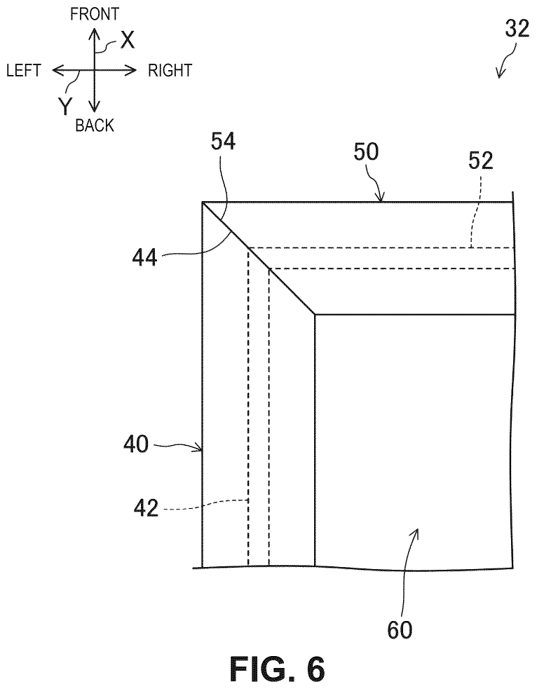

FIG. 6 shows connection between the longitudinal frame 40 and the lateral frame 50. A longitudinal-frame-side connection part 44 of the longitudinal frame 40 for the lateral frame 50 may be formed obliquely, e.g., may be oblique or inclined, to the front-rear direction and the left-right direction. The longitudinal-frame-side connection part 44 may be a portion of the longitudinal frame 40 that is connected to the lateral frame 50. In an implementation, the longitudinal-frame-side connection part 44 may be inclined relative to the front-rear direction and the left-right direction to form an inclined longitudinal connection region, the lateral-frame-side connection part 54 may be inclined to the front-rear direction and the left-right direction to form an inclined lateral connection region, and the inclined longitudinal connection region may be complementary to the inclined lateral connection region such that an end of one longitudinal rib 42 may be aligned with an end of one lateral rib 52.

A lateral-frame-side connection part 54 of the lateral frame 50 for the longitudinal frame 40 may be oblique to the front-rear direction and the left-right direction. The lateral-frame-side connection part 54 may be a portion of the lateral frame 50 that is connected to the longitudinal frame 40.

When the longitudinal-frame-side connection part 44 of the longitudinal frame 40 and the lateral-frame-side connection part 54 of the lateral frame 50 come into contact with each other, the longitudinal rib 42 of the longitudinal frame 40 and the lateral rib 52 of the lateral frame 50 may come into contact with each other.

The longitudinal ribs 42 and the lateral ribs 52 may extend over the entire circumference of a quadrangular frame without interruptions at four corners of the battery case 32.

### Joining of Base Plate to Longitudinal Frames and Lateral Frames

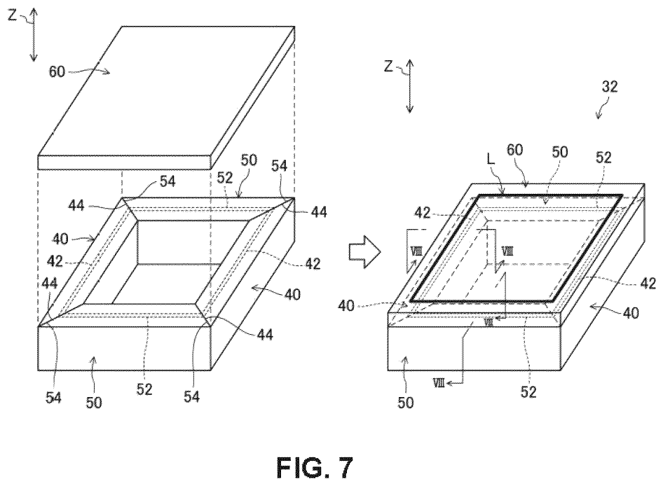

FIG. 7 shows joining of the base plate 60 to the longitudinal frames 40 and the lateral frames 50. To facilitate understanding, the top and the bottom are reversed (the upper side and the lower side are reversed) in FIG. 7. A left diagram in FIG. 7 shows a state in which the base plate 60 is detached, and a right diagram in FIG. 7 shows a state in which the base plate 60 is attached.

The base plate 60 may cover the longitudinal frames 40 and the lateral frames 50, which are assembled into a quadrangular frame shape, from at least one of the upward direction or the downward direction.

The base plate 60 may be joined to the longitudinal frames 40 and the lateral frames 50 along a joint line L. The joint line L may extend along the longitudinal ribs 42 and the lateral ribs 52 such that the joint line overlaps with the longitudinal ribs 42 and the lateral ribs 52 as viewed in the up-down direction.

The joint line L (which overlaps with the longitudinal ribs 42 and the lateral ribs 52) may extend over the entire circumference of a quadrangular frame shape without interruptions at four corners of the battery case 32.

### Method for Manufacturing Battery Unit

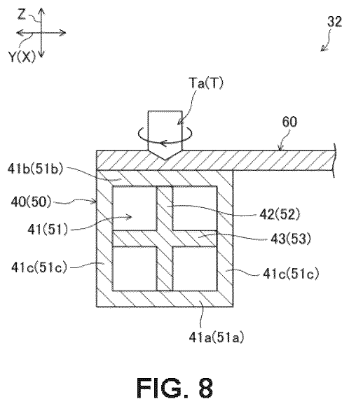

FIG. 8 shows a method for manufacturing the battery unit 30. FIG. 8 is a cross-sectional view taken along line VIII in FIG. 7. In FIG. 8, reference symbols related to the longitudinal frame 40 are indicated without brackets, and reference symbols related to the lateral frame 50 are indicated with brackets. The method for manufacturing the battery unit 30 is a method for manufacturing the battery unit 30 described above.

The base plate 60 may be joined to the longitudinal frames 40 and the lateral frames 50 along the joint line L by pressing the base plate 60 in the up-down direction with a pressing tool T along the longitudinal ribs 42 and the lateral ribs 52 with the base plate 60 overlapping with the longitudinal frames 40 and the lateral frames 50.

In an implementation, the base plate 60 may be friction stir welded to the longitudinal frames 40 and the lateral frames 50 along the joint line L by pressing the base plate 60 in the up-down direction with a rotary tool Ta, serving as the pressing tool T, while rotating the rotary tool Ta.

Friction stir welding (FSW) may be used to join a base material without melting the base material by causing the rotary tool Ta which is harder than the base material to be press-fitted (pressed) into the base material while rotating the rotary tool Ta. The rotary tool Ta may have a rod shape extending in the up-down direction. The rotary tool Ta rotates about the rotation axis extending in the up-down direction.

Friction stir welding is one kind of solid phase welding. In the friction stir welding, friction and heat that are generated by the rotation of the rotary tool Ta may help reduce deformation resistance of the base plate 60 and of the longitudinal frames 40 and the lateral frames 50. In the friction stir welding, the base plate 60, the longitudinal frames 40, and the lateral frames 50 may be caused to plastically flow and to be stirred by the movement of the rotary tool Ta. In the friction stir welding, the base plate 60, the longitudinal frames 40, and the lateral frame 50 may be integrated and joined to each other.

In the friction stir welding, a strong pressing force may be applied in the up-down direction to the base plate 60 (which is in a state of overlapping with the longitudinal frames 40 and the lateral frames 50).

### Operation and Effects

When the longitudinal-frame-side connection part 44 of the longitudinal frame 40 and the lateral-frame-side connection part 54 of the lateral frame 50 come into contact with each other, the longitudinal rib 42 of the longitudinal frame 40 and the lateral rib 52 of the lateral frame 50 come into contact with each other. Consequently, the longitudinal ribs 42 and the lateral ribs 52 extend over or around the entire circumference of a quadrangular frame shape without interruptions at four corners of the battery case 32.

The base plate 60 may be joined to the longitudinal frames 40 and the lateral frames 50 along the joint line L. The joint line L may extend along the longitudinal ribs 42 and the lateral ribs 52 such that the joint line overlaps with the longitudinal ribs 42 and the lateral ribs 52 as viewed in the up-down direction.

By pressing the base plate 60 in the up-down direction with the pressing tool T along the longitudinal ribs 42 and the lateral ribs 52 with the base plate 60 overlapping with the longitudinal frames 40 and the lateral frames 50, the base plate 60 can be joined to the longitudinal frames 40 and the lateral frames 50 along the joint line L. In pressing the base plate 60 in the up-down direction with the pressing tool T, the longitudinal ribs 42 and the lateral ribs 52 may support the base plate 60. It is possible to help suppress deflection of the base plate 60, which could otherwise be caused by pressure joining.

As has been described above, in the battery case 32 for the battery unit 30 disposed below the floor panel 8 of the vehicle A, it is possible to join the base plate 60 to the longitudinal frames 40 and the lateral frames 50 without causing deflection of the base plate 60.

By forming each of the longitudinal-frame-side connection part 44 and the lateral-frame-side connection part 54 obliquely, it may be easy for the longitudinal rib 42 and the lateral rib 52 to come into contact with each other when bringing the longitudinal-frame-side connection part 44 and the lateral-frame-side connection part 54 into contact with each other.

The rigidity of the longitudinal frame 40 and the rigidity of the lateral frame 50 can be increased by the longitudinal auxiliary rib 43 and the lateral auxiliary rib 53. This is advantageous for suppressing deflection of the base plate 60 caused by pressure joining.

In the friction stir welding, a large pressing force may be applied to the base plate 60 by the rotary tool Ta in pressing the base plate 60 in the up-down direction by the rotary tool Ta. Even in such a case, the longitudinal ribs 42 and the lateral ribs 52 may support the base plate 60 and hence it is possible to suppress deflection of the base plate 60 caused by friction stir welding.

### Second Embodiment

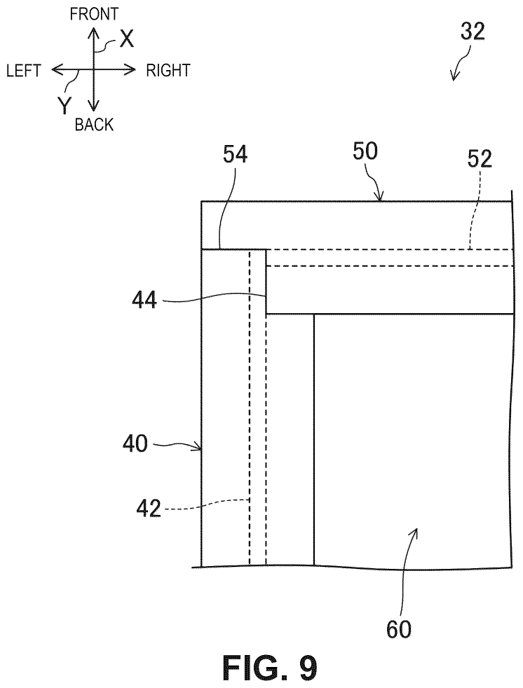

A battery unit 30 according to a second embodiment will be described. In the description made hereinafter, components similar to the corresponding components in the above-mentioned embodiment are given the same reference symbols, and the detailed description of such components will be omitted. FIG. 9 shows connection between a longitudinal frame 40 and a lateral frame 50 according to the second embodiment.

A longitudinal-frame-side connection part 44 of the longitudinal frame 40 may be formed in or have a stepped shape. A lateral-frame-side connection part 54 of the lateral frame 50 may have a stepped shape. The longitudinal-frame-side connection part 44, which may have a stepped shape, of the longitudinal frame 40 and the lateral-frame-side connection part 54, which may have a stepped shape, of the lateral frame 50 may engage with each other. In an implementation, the longitudinal-frame-side connection part 44 may have a stepped shape, the lateral-frame-side connection part 54 may have a stepped shape, and the stepped shape of the longitudinal-frame-side connection part 44 may be complementary to the stepped shape of the lateral-frame-side connection part 54 such that an end of one longitudinal rib 42 may be aligned with an end of one lateral rib 52.

When the longitudinal-frame-side connection part 44 of the longitudinal frame 40 and the lateral-frame-side connection part 54 of the lateral frame 50 come into contact with each other, the longitudinal rib 42 of the longitudinal frame 40 and the lateral rib 52 of the lateral frame 50 may also come into contact with each other.

The longitudinal ribs 42 and the lateral ribs 52 may extend over or around the entire circumference of a quadrangular frame shape without interruptions at four corners of the battery case 32.

Other configurations may be similar to the corresponding configurations of the first embodiment. According to the present embodiment, it is possible to obtain advantageous effects similar to the advantageous effects of the first embodiment. By forming each of the longitudinal-frame-side connection part 44 and the lateral-frame-side connection part 54 to have a stepped shape, it may be easy for the longitudinal rib 42 and the lateral rib 52 to come into contact with each other when bringing the longitudinal-frame-side connection part 44 and the lateral-frame-side connection part 54 into contact with each other.

### Third Embodiment

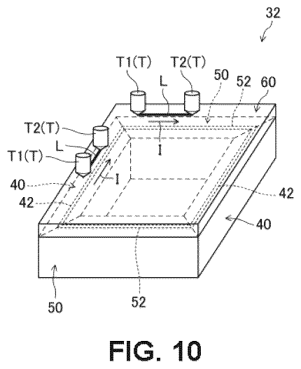

A method for manufacturing a battery unit 30 according to a third embodiment will be described. In the description made hereinafter, components similar to the corresponding components in the above-mentioned embodiment are given the same reference symbols, and the detailed description of such components will be omitted. FIG. 10 shows a method for manufacturing the battery unit 30 according to the third embodiment.

In the present embodiment, a base plate 60 may be joined to longitudinal frames 40 and lateral frames 50 by series welding.

A pressing tool T may include first electrodes T1 and second electrodes T2. The base plate 60 may be welded to the longitudinal frames 40 and the lateral frames 50 along joint lines L by passing an electric current I through the base plate 60 via the first electrodes T1 and the second electrodes T2 in a state in which the first electrode T1 and the second electrode T2 are disposed on the base plate 60 in such a way as to be arranged in line along the longitudinal rib 42, and the first electrode T1 and the second electrode T2 are disposed on the base plate 60 in such a way as to be arranged in line along the lateral rib 52.

The first electrode T1 and the second electrode T2 (that serve as pressing tools T) may press the base plate 60 (which is in a state of overlapping with the longitudinal frames 40 and the lateral frames 50) in the up-down direction. A pressing force caused by the first electrode T1 and the second electrode T2 may be smaller than a pressing force caused by the rotary tool Ta at the time of performing friction stir welding.

### Other Embodiments

Although the present disclosure has been described with reference to the preferred embodiments heretofore, needless to say, such description is not a limitation, and various modifications, replacement, or combinations can be made. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated.

In an implementation, the base plate 60 may cover the longitudinal frames 40 and the lateral frames 50, which are assembled into a quadrangular frame shape, from the downward direction (the bottom direction). In an implementation, the base plate 60 may cover the longitudinal frames 40 and the lateral frames 50, which are assembled into a quadrangular frame shape, from the upward direction, e.g., from the top. In an implementation, two base plates 60 may cover the longitudinal frames 40 and the lateral frames 50, which are assembled into a quadrangular frame shape, from both the upward direction and the downward direction (from above and below). In an implementation, the base plate 60 may only have to cover the longitudinal frames 40 and the lateral frames 50, which are assembled into a quadrangular frame shape, from at least one of the upward direction or the downward direction.

In an implementation, the joint line L may overlap with the longitudinal ribs 42 and the lateral ribs 52 as viewed in the up-down direction, and the joint line L may be interrupted in the middle. In an implementation, the joint line L may be discontinuously provided in a quadrangular frame shape in such a way as to overlap with the longitudinal ribs 42 and the lateral ribs 52 as viewed in the up-down direction.

In an implementation, the base plate 60 may be joined to the longitudinal frames 40 and the lateral frames 50 by friction stir welding or series welding. In an implementation, the base plate 60 may be joined to the longitudinal frames 40 and the lateral frames 50 by common resistance welding (a method in which the components are interposed between an upper electrode and a lower electrode). In an implementation, the base plate 60 may be joined to the longitudinal frames 40 and the lateral frames 50 by other joining methods.

### INDUSTRIAL APPLICABILITY

Since the present disclosure is applicable to a battery unit, it is extremely useful and has high industrial applicability.

### REFERENCE SIGNS LIST

X front-rear direction
Y left-right direction
Z up-down direction
T pressing tool
Ta rotary tool
T1 first electrode
T2 second electrode
L joint line
I electric current
A vehicle
1 vehicle body
1a front space
1b vehicle cabin
2 bumper beam
3 shroud upper member
4 apron member
5 front side frame
6 side sill
7 dash panel
8 floor panel
8a edge part
9 rear side frame
9a rear floor panel
10 torque box
11 suspension housing
12 crush can
30 battery unit
31 battery cell
32 battery case
40 longitudinal frame
41 hollow cross section
41a upper end
41b lower end
41c both lateral ends
42 longitudinal rib
43 longitudinal auxiliary rib
44 longitudinal-frame-side connection part
50 lateral frame
51 hollow cross section
51a upper end
51b lower end
51c both lateral ends
52 lateral rib
53 lateral auxiliary rib
54 lateral-frame-side connection part
60 base plate
130 battery unit
132 battery case
140 longitudinal frame
142 longitudinal rib
150 lateral frame
152 lateral rib
160 plate member
N ribless portion

1. A battery unit disposed below a floor panel of a vehicle, the battery unit including a battery cell housed in a battery case, wherein:
the battery case includes
a pair of longitudinal frames extending in parallel with a front-rear direction,
a pair of lateral frames extending in parallel with a left-right direction, and
a base plate extending in the front-rear direction and the left-right direction,
the pair of longitudinal frames and the pair of lateral frames are assembled into a quadrangular frame shape in such a way as to surround the battery cell,
each longitudinal frame of the pair of longitudinal frames includes a longitudinal rib that couples an upper end and a lower end of a hollow cross section to each other, the longitudinal rib extending in the front-rear direction,
each lateral frame of the pair of lateral frames includes a lateral rib that couples an upper end and a lower end of a hollow cross section to each other, the lateral rib extending in the left-right direction,
a longitudinal-frame-side connection part of each longitudinal frame for the pair of lateral frames and a lateral-frame-side connection part of each lateral frame for the pair of longitudinal frames contact each other such that the longitudinal ribs and the lateral ribs contact each other,
the base plate covers the pair of longitudinal frames and the pair of lateral frames, which are assembled into the quadrangular frame shape, from at least one of an upward direction or a downward direction, and
the base plate is joined to the pair of longitudinal frames and the pair of lateral frames along a joint line, the joint line extending along the longitudinal ribs and the lateral ribs such that the joint line overlaps with the longitudinal ribs and the lateral ribs as viewed in an up-down direction.

2. The battery unit according to claim 1, wherein:
the longitudinal-frame-side connection part is oblique to the front-rear direction and the left-right direction, and
the lateral-frame-side connection part is oblique to the front-rear direction and the left-right direction.

3. The battery unit according to claim 1, wherein:
the longitudinal-frame-side connection part has a stepped shape,
the lateral-frame-side connection part has a stepped shape, and
the longitudinal-frame-side connection part having a stepped shape and the lateral-frame-side connection part having a stepped shape engage with each other.

4. The battery unit according to claim 1, wherein
each longitudinal frame of the pair of longitudinal frames includes a longitudinal auxiliary rib that couples opposite lateral ends of the hollow cross section to each other, the longitudinal auxiliary rib extending in the front-rear direction, and
each lateral frame of the pair of lateral frames includes a lateral auxiliary rib that couples opposite lateral ends of the hollow cross section to each other, the lateral auxiliary rib extending in the left-right direction.

5. A method for manufacturing the battery unit according to claim 1, wherein the base plate is joined to the pair of longitudinal frames and the pair of lateral frames along the joint line by pressing the base plate with a pressing tool along the longitudinal ribs and the lateral ribs with the base plate overlapping with the pair of longitudinal frames and the pair of lateral frames.

6. The method for manufacturing the battery unit according to claim 5, wherein:
the pressing tool is a rotary tool, and
the base plate is friction stir welded to the pair of longitudinal frames and the pair of lateral frames along the joint line by pressing the base plate with the rotary tool while rotating the rotary tool.

7. The method for manufacturing the battery unit according to claim 5, wherein:
the pressing tool includes a first electrode and a second electrode, and
the base plate is welded to the longitudinal frame and the lateral frame along the joint line by passing an electric current through the base plate via the first electrode and the second electrode in a state in which the first electrode and the second electrode are on the base plate in such a way as to be arranged in line along the longitudinal ribs or the lateral ribs.

8. The battery unit according to claim 1, wherein:
the longitudinal-frame-side connection part is inclined relative to the front-rear direction and the left-right direction to form an inclined longitudinal connection region,
the lateral-frame-side connection part is inclined to the front-rear direction and the left-right direction to form an inclined lateral connection region, and
the inclined longitudinal connection region is complementary to the inclined lateral connection region such that an end of one longitudinal rib is aligned with an end of one lateral rib.

9. The battery unit according to claim 1, wherein:
the longitudinal-frame-side connection part has a stepped shape,
the lateral-frame-side connection part has a stepped shape, and
the stepped shape of the longitudinal-frame-side connection part is complementary to the stepped shape of the lateral-frame-side connection part such that an end of one longitudinal rib is aligned with an end of one lateral rib.

10. A vehicle including the battery unit according to claim 1.
